(19) United States
(12) Patent Application Publication
(10) Pub. No.: US 2009/0120661 A1
(43) Pub. Date: May 14, 2009

(54) PROTECTIVE STRUCTURE FOR HIGH VOLTAGE CABLE

(75) Inventors: Yukari Inoue, Aichi-ken (JP); Hitoshi Imura, Aichi-ken (JP)

Correspondence Address: SUGHRUE MION, PLLC, 2100 PENNSYLVANIA AVENUE, N.W., SUITE 800, WASHINGTON, DC, 20037, US

(73) Assignee: TOYOTA JIDOSHA KABUSHIKI KAISHA, TOYOTA-SHI, AICHI-KEN (JP)

(21) Appl. No.: 12/091,140

(22) PCT Filed: Nov. 8, 2006
(86) PCT No.: PCT/JP2006/322702

§ 371 Date: Apr. 22, 2008

(30) Foreign Application Priority Data
Nov. 11, 2005 (JP) 2005-327824

(51) Int. Cl. H01B 3/30

(52) U.S. Cl. 174/110 SR

(57) ABSTRACT

A protective structure for a high voltage cable includes a boost converter and a rear inverter installed in a hybrid vehicle and disposed to be separated from each other; a cable extending between the boost converter and the rear inverter; a protector provided in at least a section of a route along which the cable extends; and a flexible tube surrounding a circumference of the cable inside the protector and freely curved along a direction in which the cable extends. When external force is applied to the cable, the external force is reduced by the protector and the flexible tube. With such a configuration, a protective structure for a high voltage cable that prevents an excessive impact from being exerted on the cable in the event of a vehicle crash is provided.

### TECHNICAL FIELD

The present invention generally relates to a protective structure for a high voltage cable, and more particularly, to a protective structure for a high voltage cable extending between electronic components installed in a vehicle.

### BACKGROUND ART

Concerning a conventional protective structure for a high voltage cable, a drive apparatus for a hybrid vehicle intended to improve safety of the vehicle in the event of a vehicle crash by avoiding breakage, damage, and the like of a power supply cable is disclosed for example in Japanese Patent Laying-Open Nos. 2005-104387 and 2005-104386.

In Japanese Patent Laying-Open No. 2005-104387, a power supply cable connecting a stator coil of an electric power generation motor and an inverter extends through a floor tunnel. Two reinforcing ribs are provided on a surface of a gear case accommodating a transmission. A cable accommodating groove accommodating the power supply cable is formed between the two reinforcing ribs. The gear case is provided with a protective cover to cover the cable accommodating groove.

On the other hand, in Japanese Patent Laying-Open No. 2005-104386, a power supply cable is provided along a gear case. The gear case is provided with a protective cover to cover the power supply cable. In Japanese Patent Laying-Open No. 2005-104387, a circumference of the power supply cable is surrounded by a surface of the cable accommodating groove and the protective cover, and in Japanese Patent Laying-Open No. 2005-104386, a circumference of the power supply cable is surrounded by a surface of the gear case and the protective cover.

Further, Japanese Patent Laying-Open No. 2004-82940 discloses an electric power conversion apparatus for a vehicle intended to dispose a PCU (Power Control Unit) inside an engine room to suppress interference with other components installed in the vehicle as much as possible. The PCU includes an inverter and a converter. In Japanese Patent Laying-Open No. 2004-82940, the PCU disposed inside the engine room is connected to two power sources having different voltages and to a motor generator, by power cables.

In Japanese Patent Laying-Open Nos. 2005-104387 and 2005-104386 described above, a direction in which the power supply cable is curved in the event of a vehicle crash is predetermined by the cable accommodating groove provided in the surface of the gear case and the protective cover. This prevents the power supply cable from being sandwiched between the gear case and a vehicle body. On this occasion, however, it is necessary to secure a space on the surface of the gear case to allow the power supply cable to move aside. In a vehicle incapable of securing such a space, it is inevitable that an excessive impact is exerted on a power supply cable in the event of a vehicle crash.

### DISCLOSURE OF THE INVENTION

One object of the present invention is to solve the aforementioned problem, and to provide a protective structure for a high voltage cable that prevents an excessive impact from being exerted on the cable in the event of a vehicle crash.

A protective structure for a high voltage cable in accordance with the present invention includes: first and second electric components installed in a vehicle and disposed to be separated from each other; a cable extending between the first electric component and the second electric component; a resin molded protector provided in at least a section of a route along which the cable extends; and a tube member surrounding a circumference of the cable inside the resin molded protector and freely curved along a direction in which the cable extends. When external force is applied to the cable, the external force is reduced by the resin molded protector and the tube member.

According to the protective structure for a high voltage cable with such a configuration, the external force applied to the cable is reduced by the resin molded protector and the tube member. Therefore, even in a vehicle having difficulty in securing a space on the route of the cable, it is possible to prevent an excessive impact from being exerted on the cable in the event of a vehicle crash. Further, since double protection is provided by the resin molded protector and the tube member in the section provided with the resin molded protector, an impact to the cable can be reduced more effectively.

Preferably, the entire circumference of the cable is surrounded by the resin molded protector in the above section.

Preferably, the resin molded protector has a strength greater than that of the tube member.

Preferably, the cable is provided to be moveable along the direction in which the cable extends inside the resin molded protector.

Preferably, the resin molded protector has a main body having an opening formed therein to be open along the direction in which the cable extends and accommodating the cable, and a lid attached to the main body to close the opening.

Further, a component that constitutes the vehicle and is a rigid body is provided at a position separated from the first and second electric components in a substantially horizontal direction. The resin molded protector is disposed between at least either of the first and second electric components and the component.

As described above, according to the present invention, a protective structure for a high voltage cable that prevents an excessive impact from being exerted on the cable in the event of a vehicle crash can be provided.

### BRIEF DESCRIPTION OF THE DRAWINGS

FIG. 1 is a block diagram of a high voltage system installed in a hybrid vehicle.

FIG. 2 is a plan view of a hybrid vehicle to which a protective structure for a high voltage cable in a first embodiment of the present invention is applied.

FIG. 3 is a side view inside an engine room along the line III-III in FIG. 2.

FIG. 4 is a cross sectional view of a protector along the line IV-IV in FIG. 3.

FIG. 5 is a cross sectional view showing a variation of the protector shown in FIG. 4.

FIG. 6 is a plan view of a hybrid vehicle to which a protective structure for a high voltage cable in a second embodiment of the present invention is applied.

FIG. 7 is a plan view of a hybrid vehicle to which a protective structure for a high voltage cable in a third embodiment of the present invention is applied.

### BEST MODES FOR CARRYING OUT THE INVENTION

Embodiments of the present invention will be described with reference to the drawings, in which identical or corresponding members are denoted by the same numerals.

### First Embodiment

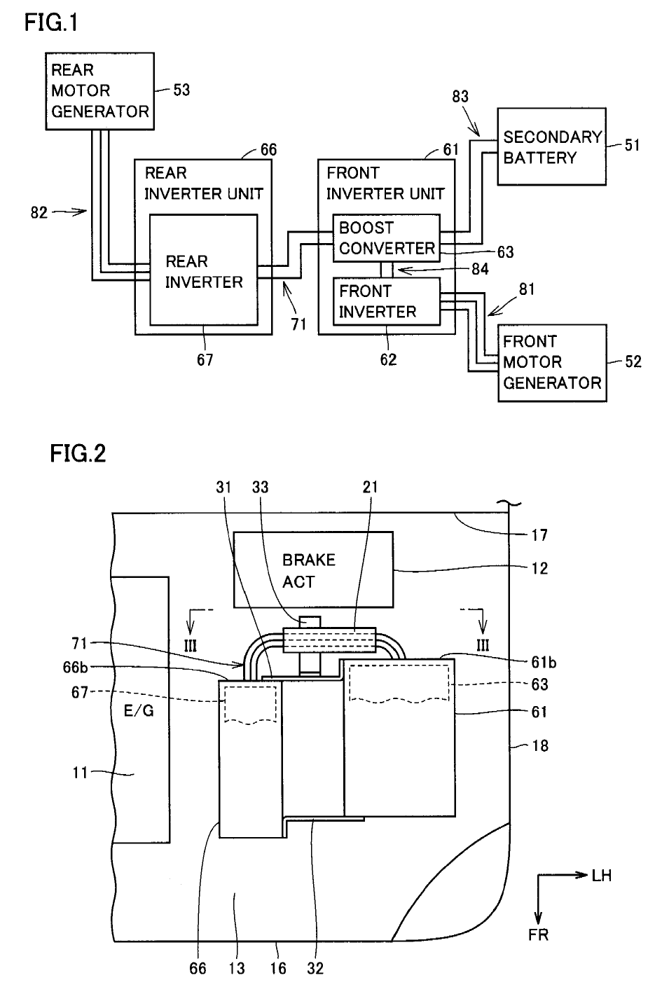

FIG. 1 is a block diagram of a high voltage system installed in a hybrid vehicle. A protective structure for a high voltage cable in a first embodiment of the present invention is applied to a hybrid vehicle powered by an internal combustion engine such as a gasoline engine or a diesel engine, and a chargeable and dischargeable secondary battery.

Referring to FIG. 1, the hybrid vehicle is equipped with a secondary battery 51, a front motor generator 52, a front inverter unit 61, a rear motor generator 53, and a rear inverter unit 66. Front inverter unit 61 accommodates a boost converter 63 and a front inverter 62. Rear inverter unit 66 accommodates a rear inverter 67.

Secondary battery 51 and boost converter 63 are connected by a cable 83. Boost converter 63 and front inverter 62 are connected by a cable 84 inside front inverter unit 61. Boost converter 63 and rear inverter 67 are connected by a cable 71. Cables 83, 84, and 71 are each formed of a positive cable and a negative cable.

Front inverter 62 and front motor generator 52 are connected by a cable 81. Rear inverter 67 and rear motor generator 53 are connected by a cable 82. Cables 81 and 82 are formed of a three-phase cable including U phase, V phase, and W phase cables.

FIG. 2 is a plan view of a hybrid vehicle to which the protective structure for a high voltage cable in the first embodiment of the present invention is applied. Referring to FIGS. 1 and 2, an engine room 13 equipped with an engine 11 is formed in the hybrid vehicle. Engine room 13 is formed on a front side of the vehicle. Engine room 13 is formed between a front bumper 16 and a dashboard panel 17. Dashboard panel 17 separates engine room 13 from an interior of the vehicle.

In engine room 13, front inverter unit 61 and rear inverter unit 66 are provided to be separated from each other. Front inverter unit 61 and rear inverter unit 66 are arranged side by side in a width direction of the vehicle. Rear inverter unit 66 and engine 11 are adjacent in the width direction of the vehicle and separated from each other. Rear inverter unit 66 is disposed between engine 11 and front inverter unit 61. Front inverter unit 61 is disposed at a position adjacent to a side body 18. Front inverter unit 61 is disposed between rear inverter unit 66 and side body 18.

In engine room 13, a brake actuator 12 as a rigid-body component is also provided. Brake actuator 12 is disposed between dashboard panel 17 and both of front inverter unit 61 and rear inverter unit 66. Brake actuator 12 and both of front inverter unit 61 and rear inverter unit 66 are arranged side by side in a direction in which the vehicle moves, and separated from each other. Brake actuator 12 and engine 11 are arranged side by side in the width direction of the vehicle, and separated from each other.

Front motor generator 52 has functions such as supporting output of the engine to enhance driving power of front tires, and generating electric power by regenerative braking during deceleration. Front motor generator 52 is disposed immediately below engine 11. Rear motor generator 53 has functions such as driving rear tires, and generating electric power by regenerative braking during deceleration. Rear motor generator 53 is provided on an axle of the rear tires on a rear side of the vehicle.

Secondary battery 51 has functions such as supplying electric power to front motor generator 52 and rear motor generator 53 at startup, during acceleration, when driving up a slope, and the like, and storing electric power regeneratively generated by front motor generator 52 and rear motor generator 53 during deceleration. Secondary battery 51 is not particularly limited as long as it is a chargeable and dischargeable battery, and it may be, for example, a nickel hydride battery or a lithium ion battery.

Secondary battery 51 is disposed, for example, in a luggage room provided on the rear side of the vehicle. Second battery 51 may be disposed, for example, below a front seat or a rear seat, below a center console provided between a driver seat and a passenger seat of the front seats, or the like. In a case where the vehicle has seats in three rows, secondary battery 51 may be disposed below a second seat or a third seat.

Boost converter 63 has functions such as boosting electric power input from secondary battery 51 to front inverter 62 or rear inverter 67, and reducing a voltage input from these inverters to secondary battery 51. Front inverter 62 and rear inverter 67 have functions such as converting a direct current boosted by boost converter 63 into an alternating current for driving the motor, and converting an alternating current generated by the generator into a direct current for charging secondary battery 51.

A current boosted by boost converter 63, that is, a current flowing into cables 81, 84, 71, and 82, has a voltage of not less than 500 V. A current boosted by boost converter 63 may have a voltage of not less than 650 V. A current flowing between secondary battery 51 and boost converter 63, that is, a current flowing into cable 83, has a voltage of not less than 200 V.

Brake actuator 12 adjusts a braking pressure to each wheel cylinder according to a control signal from a skid control computer to control a rotation state of each wheel and change a hydraulic circuit according to each control (such as ABS (Anti-lock Brake System), traction control, brake assist and the like).

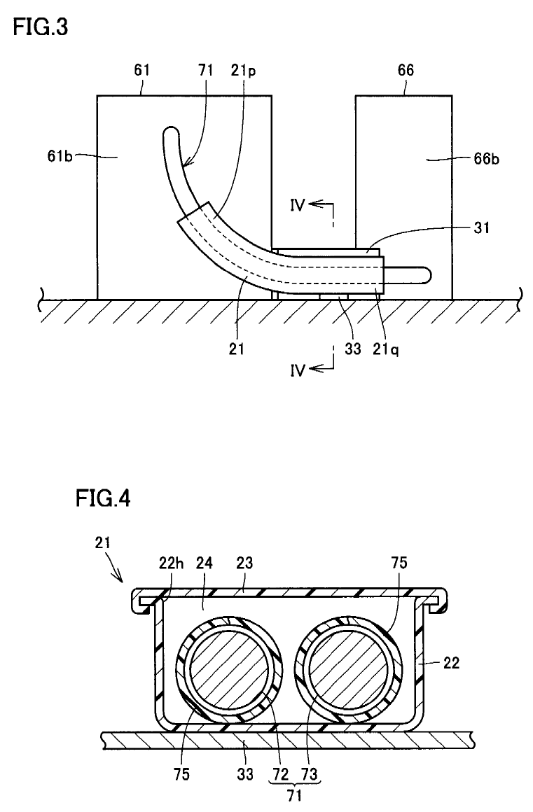

FIG. 3 is a side view inside the engine room along the line III-III in FIG. 2. Referring to FIGS. 2 and 3, front inverter unit 61 and rear inverter unit 66 have side faces 61b and 66b, respectively, facing brake actuator 12. Side faces 61b and 66b face in the same direction.

Cable 71 connecting between boost converter 63 and rear inverter 67 extends from side face 61b of front inverter unit 61 to side face 66b of rear inverter unit 66. Cable 71 passes through a space between brake actuator 12 and both of front inverter unit 61 and rear inverter unit 66.

Front inverter unit 61 and rear inverter unit 66 are coupled to each other with plates 31 and 32. Plate 31 disposed at a position facing brake actuator 12 is provided with a protector fixing seat 33. Protector fixing seat 33 may be provided as a member separate from plate 31, or may be provided as a member integral with plate 31. In the present embodiment, plate 31 and protector fixing seat 33 serve as protector fixing members.

A protector 21 is fixed to protector fixing seat 33. Protector 21 is formed by resin molding using polypropylene, polyethylene, nylon, butyl rubber, fluororesin, or the like. Protector 21 has a cylindrical shape. Cable 71 is inserted into protector 21. Protector 21 is provided in a section of a range between boost converter 63 and rear inverter 67 through which cable 71 extends.

Protector 21 has rigidity such that it is undeformable at least when cable 71 is inserted thereinto. In the section provided with protector 21, a route along which cable 71 extends is determined by protector 21. In other words, the shape of protector 21 is determined according to the route of cable 71 to be set.

In the present embodiment, protector 21 is provided in a section of a range between side face 61b and side face 66b through which cable 71 extends. Protector 21 has one end 21p positioned at a prescribed distance from side face 61b, and an other end 21q positioned at a prescribed distance from side face 66b. One end 21p is positioned higher than the other end 21q. Protector 21 extends to be curved between one end 21p and the other end 21q. With protector 21 having such a shape, the route of cable 71 is defined to be directed in a vertically downward direction, from side face 61b to side face 66b.

Protector 21 is provided to surround an entire circumference of cable 71. Protector 21 is disposed in a space between brake actuator 12 and both of front inverter unit 61 and rear inverter unit 66. Protector 21 is disposed at a position separated from the functional components supporting driving of the hybrid vehicle, such as front inverter unit 61, rear inverter unit 66, and brake actuator 12.

FIG. 4 is a cross sectional view of the protector along the line IV-IV in FIG. 3. Referring to FIG. 4, a positive cable 72 and a negative cable 73 constituting cable 71 are shown in the drawing. Positive cable 72 and negative cable 73 are each formed of a stranded metal wire coated with an insulating film not shown. Positive cable 72 and negative cable 73 are provided with a flexible tube 75 surrounding a circumference of each cable inside protector 21. Flexible tube 75 is provided in a section longer than that of protector 21. Flexible tube 75 is provided between boost converter 63 and rear inverter 67.

Flexible tube 75 is a hollow tube with a surface having bellows formed thereon. Flexible tube 75 is made of a resin material such as polypropylene, for example. Together with protector 21, flexible tube 75 serves to reduce an impact exerted on cable 71, and also serves to protect cable 71 from vibration and avoid interference between cable 71 and other components.

Protector 21 has a strength greater than that of flexible tube 75. The strengths of protector 21 and flexible tube 75 are measured in the following manner. Firstly, protector 21 and flexible tube 75 with the same length (i.e., the length in a direction in which inserted cable 71 extends) are prepared, and both ends thereof are supported. Forces of the same magnitude are applied to the respective centers between the supported ends of protector 21 and flexible tube 75. Deflection volumes of protector 21 and flexible tube 75 are measured at points on which the forces are applied. On this occasion, the deflection volume of protector 21 is smaller than the deflection volume of flexible tube 75. The difference in the strengths of protector 21 and flexible tube 75 may be derived from the difference in materials thereof or the difference in shapes thereof.

While protector 21 is undeformable at least when cable 71 is inserted thereinto, flexible tube 75 is freely curved along a direction in which cable 71 extends, with cable 71 inserted thereinto. That is, the route along which cable 71 extends is not determined by flexible tube 75.

Protector 21 has a main body 22 having an opening 22h formed therein, and a lid 23 attached to main body 22 to close opening 22h. Main body 22 forms a space 24 accommodating cable 71. Opening 22h is continuously open along the direction in which cable 71 extends. Opening 22h that is open along the direction in which cable 71 extends is formed in protector 21. Main body 22 and lid 23 are fixed to each other by engaging resin molded components. Protector 21 has a substantially rectangular cross sectional shape that is short in a vertical direction and long in a horizontal direction. Opening 22h is open along a relatively long side of the substantially rectangular cross sectional shape.

Cable 71 is provided to be moveable along the direction in which cable 71 extends inside protector 21. A gap is secured between an internal wall of protector 21 and cable 71.

During a manufacturing process of the hybrid vehicle, an operator connects boost converter 63 with rear inverter 67 by cable 71, and then attaches protector 21 to cable 71. On this occasion, the operator firstly provides main body 22 at an appropriate position of cable 71 where it is easy for the operator to attach main body 22, and then attaches lid 23 to main body 22. Thereafter, the operator slides protector 21 in the direction in which cable 71 extends, and moves protector 21 to a position to be provided shown in FIGS. 2 and 3. Finally, the operator fixes protector 21 to protector fixing seat 33, thus completing an attaching operation of protector 21.

Specifically, a method of attaching the protective structure for a high voltage cable in the first embodiment of the present invention includes the steps of providing protector 21 to cable 71, and sliding protector 21 in the direction in which cable 71 extends.

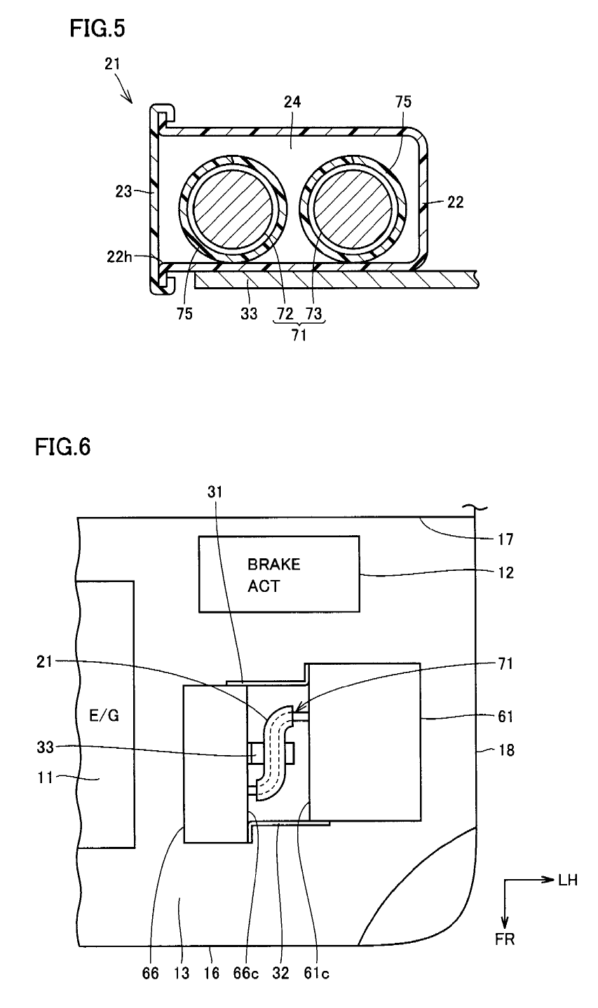

FIG. 5 is a cross sectional view showing a variation of the protector shown in FIG. 4. Referring to FIG. 5, in the present variation, protector 21 has a substantially rectangular cross sectional shape that is short in a vertical direction and long in a horizontal direction. Opening 22h is open along a relatively short side of the substantially rectangular cross sectional shape. With this configuration, opening 22h can have a smaller opening area when compared to protector 21 shown in FIG. 4. Thereby, the strength of protector 21 can be improved.

Protector 21 has main body 22 having opening 22h formed therein, and lid 23 attached to main body 22 to close opening 22h. Protector 21 has a cross sectional shape having a first side that is relatively long and a second side that is relatively short. Opening 22h is formed to be open along the second side.

The protective structure for a high voltage cable in the first embodiment of the present invention includes: boost converter 63 and rear inverter 67 as first and second electric components installed in a hybrid vehicle as a vehicle and disposed to be separated from each other; cable 71 extending between boost converter 63 and rear inverter 67; protector 21 as a resin molded protector provided in at least a section of a route along which cable 71 extends; and flexible tube 75 as a tube member surrounding the circumference of cable 71 inside protector 21 and freely curved along a direction in which cable 71 extends. When external force is applied to cable 71, the external force is reduced by protector 21 and flexible tube 75.

Protector 21 as the resin molded protector defines the route along which cable 71 extends in the section described above.

According to the protective structure for a high voltage cable in the first embodiment of the present invention with such a configuration, when cable 71 is sandwiched between front inverter unit 61 and brake actuator 12 or between rear inverter unit 66 and brake actuator 12 in the event of a vehicle crash, a double structure formed of protector 21 and flexible tube 75 can prevent excessive force from being exerted on cable 71. Accordingly, in the present embodiment, there is no need to secure a space inside engine room 13 to allow cable 71 to move aside in the event of a vehicle crash, and thus cable 71 can be appropriately protected even if it is installed in engine room 13 having considerable space limitations.

Further, in the present embodiment, protector 21 is provided to surround the entire circumference of cable 71. Accordingly, even when protector 21 is disposed at a position separated from front inverter unit 61, rear inverter unit 66, and brake actuator 12, protector 21 can reliably protect cable 71 from an impact exerted from all sides of protector 21. Therefore, the route of cable 71 is not limited to a route along surfaces of side faces 61b and 66b and a surface of brake actuator 12, and can be freely set in an open space inside engine room 13. In other words, it is not always necessary to secure a space for disposing cable 71 in the vicinity of front inverter unit 61, rear inverter unit 66, and brake actuator 12, and thus space saving inside engine room 13 can be achieved effectively.

Although protector 21 is provided only in a section of the route along which cable 71 extends in the present embodiment, protector 21 may be provided in all the sections of the route along which cable 71 extends.

Further, although the present invention is applied to a hybrid vehicle powered by an internal combustion engine and a secondary battery in the present embodiment, the present invention is not limited thereto. The present invention is also applicable to a fuel cell hybrid vehicle (FCHV) powered by a fuel cell and a secondary battery, or an electric vehicle (EV). In the hybrid vehicle in the present embodiment, the internal combustion engine is driven at an operating point of optimal fuel efficiency, whereas in the fuel cell hybrid vehicle, the fuel cell is driven at an operating point of optimal electric power generation efficiency. The secondary battery is used basically in the same manner in both of the hybrid vehicles.

Further, secondary battery 51 producing electricity by itself from chemical change or the like may be replaced by an electric power storage apparatus storing electricity supplied externally such as a capacitor or the like.

The capacitor refers to an electric double layer capacitor based on the operating principle of an electric double layer formed at an interface between activated carbon and an electrolyte solution. When the activated carbon used as a solid and the electrolyte solution (dilute sulfuric acid solution) used as a liquid are brought into contact with each other, positive and negative electrodes are relatively distributed at the interface at a very short distance therebetween. When a pair of electrodes are immersed into an ionic solution to apply voltage thereto to the extent not to cause electrolysis, ions are adsorbed onto surfaces of the respective electrodes, and positive electricity and negative electricity are stored (i.e., charge). When electricity is released to the outside, positive and negative ions are separated from the electrodes, and thus the electrodes return to a neutralized state (i.e., discharge).

### Second Embodiment

FIG. 6 is a plan view of a hybrid vehicle to which a protective structure for a high voltage cable in a second embodiment of the present invention is applied. The protective structure for a high voltage cable in the present embodiment has a structure basically similar to the protective structure for a high voltage cable in the first embodiment. Hereinafter, description of the same components will not be repeated.

Referring to FIG. 6, front inverter unit 61 and rear inverter unit 66 have side faces 61c and 66c, respectively, facing each other. Side faces 61c and 66c face in the width direction of the vehicle. In the present embodiment, cable 71 connecting between boost converter 63 and rear inverter 67 extends from side face 61c of front inverter unit 61 to side face 66c of rear inverter unit 66. Cable 71 passes through a space between front inverter unit 61 and rear inverter unit 66.

Protector 21 is fixed to protector fixing seat 33 provided between side faces 61c and 66c. Cable 71 is inserted into protector 21. Protector 21 defines a route along which cable 71 extends between side faces 61c and 66c.

According to the protective structure for a high voltage cable in the second embodiment of the present invention with such a configuration, the effect similar to the effect described in the first embodiment can be obtained even when cable 71 is sandwiched between front inverter unit 61 and rear inverter unit 66.

### Third Embodiment

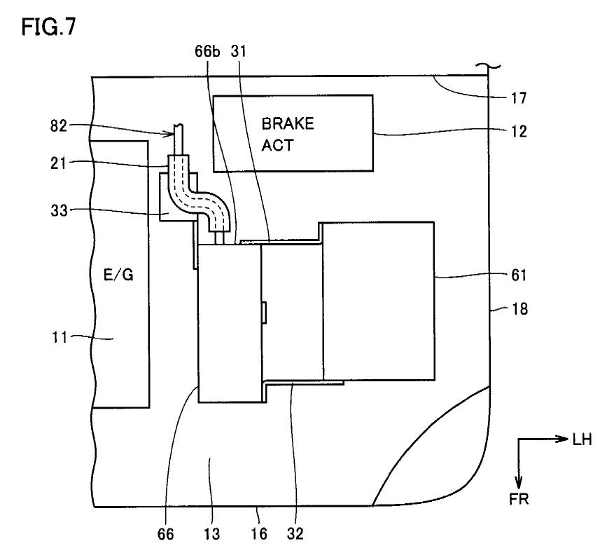

FIG. 7 is a plan view of a hybrid vehicle to which a protective structure for a high voltage cable in a third embodiment of the present invention is applied. The protective structure for a high voltage cable in the present embodiment has a structure basically similar to the protective structure for a high voltage cable in the first embodiment. Hereinafter, description of the same components will not be repeated.

Referring to FIG. 7, in the present embodiment, cable 82 connecting between rear inverter 67 and rear motor generator 53 extends from side face 66b of rear inverter unit 66 to the rear side of the vehicle. Cable 82 passes through a position surrounded by brake actuator 12, engine 11, and rear inverter unit 66.

Protector 21 is fixed to protector fixing seat 33 provided at the position surrounded by brake actuator 12, engine 11, and rear inverter unit 66. Cable 82 is inserted into protector 21. Protector 21 defines a route along which cable 82 extends at the position surrounded by brake actuator 12, engine 11, and rear inverter unit 66.

According to the protective structure for a high voltage cable in the third embodiment of the present invention with such a configuration, the effect similar to the effect described in the first embodiment can be obtained.

It is to be noted that the cable in the present invention is not limited to cables 71 and 82 described in the first to the third embodiments, and may be cables 81 and 83 shown in FIG. 1. Further, in a case where boost converter 63 and front inverter 62 are provided separately, the cable in the present invention may be cable 84 connecting between boost converter 63 and front inverter 62. Furthermore, the position where the resin molded protector is disposed is not limited to the positions described in the first to the third embodiments, and may be disposed, for example, in a space between engine 11 and rear inverter unit 66, a space between front bumper 16 and both of front inverter unit 61 and rear inverter unit 66, a space between front inverter unit 61 and side body 18, or the like in FIG. 2.

The embodiments disclosed herein are by way of example in all respects and should not be interpreted as restrictive. The scope of the present invention is determined not by the above description but by the appended claims, and intended to include all the modifications within the meaning and the scope equivalent to those of the claims.

### INDUSTRIAL APPLICABILITY

The present invention is mainly applicable to protection of a cable for a high voltage system installed in a hybrid vehicle.

1. A protective structure for a high voltage cable, comprising:
a first electric component and a second electric component installed in a vehicle and disposed to be separated from each other;
a cable extending between said first electric component and said second electric component;
a resin molded protector provided in at least a section of a route along which said cable extends; and
a tube member surrounding a circumference of said cable inside said resin molded protector and freely curved along a direction in which said cable extends,
said resin molded protector being disposed between at least either of said first electric component and said electric component and a component disposed rearward of said first electric component and said second electric component with respect to the vehicle,
when external force is applied to said cable, the external force being reduced by said resin molded protector and said tube member.

2. The protective structure for a high voltage cable according to claim 1, wherein the entire circumference of said cable is surrounded by said resin molded protector in said section.

3. The protective structure for a high voltage cable according to claim 1, wherein said resin molded protector has a strength greater than that of said tube member.

4. The protective structure for a high voltage cable according to claim 1, wherein said cable is provided to be moveable along the direction in which said cable extends inside said resin molded protector.

5. The protective structure for a high voltage cable according to claim 1, wherein said resin molded protector has a main body having an opening formed therein to be open along the direction in which said cable extends and accommodating said cable, and a lid attached to said main body to close said opening.

6. The protective structure for a high voltage cable according to claim 1, wherein
said component that constitutes said vehicle and is a rigid body is provided at a position separated from said first electric component and said second electric component in a substantially horizontal direction.
